(19) United States
(12) Patent Application Publication
(10) Pub. No.: US 2025/0371411 A1
(43) Pub. Date: Dec. 4, 2025

(54) SYSTEMS AND METHODS FOR PREDICTING CONDITION OF AN ENTITY VIA MACHINE-LEARNING

(71) Applicant: Optum, Inc., Minnetonka, MN (US)

(72) Inventors: Anurag SINHA, Noida (IN); Arun Kumar TIWARI, New Delhi (IN); Mohit SINGHAL, Delhi (IN); Amardeep SHARMA, Delhi (IN); Akhil SRIVASTAVA, Greater Noida West (IN); Piyush RAUT, Brahmapuri (IN); KM Garima Misra, Mohammadi (IN)

(21) Appl. No.: 18/679,924

(22) Filed: May 31, 2024

(51) Int. Cl. G06N 20/00

(52) U.S. Cl. CPC G06N 20/00

(57) ABSTRACT

Systems and methods are disclosed for training a machine-learning model to predict and manage a condition of an entity. The method includes receiving historical data associated with a target entity from a plurality of data sources; deriving feature(s) from the historical data; determining a condition of the target entity by applying the feature(s) to a machine-learning model trained by: receiving a plurality of datasets associated with each entity of a plurality of entities; determining a specific condition associated with each entity based on the plurality of datasets; generating an identifier for each entity based on the determined specific condition; deriving training feature(s) for each entity from historical training data associated with the entity; and inputting the identifier and the training feature(s) for each entity to the machine-learning model to learn associations between the identifiers and the training feature(s) associated with the plurality of entities.

### TECHNICAL FIELD

This present disclosure relates generally to the field of data processing and predictive analytics. In particular, the present disclosure relates to analyzing data utilizing machine-learning methodologies for predicting the condition of an entity.

### BACKGROUND

In data analysis, certain datasets (e.g., categorical identifiers) either remain undetected or surface after significant temporal intervals. The delayed or absent encoding of these identifiers not only impedes timely analysis but also highlights deficiencies in current data capture and analysis methodologies. Undiagnosed conditions further compound this challenge, acting as significant roadblocks to predictive modeling and analytics. Conventional approaches often rely on static models that struggle to accommodate the dynamic nature of incomplete or delayed data inputs, leading to inaccuracies and suboptimal predictions. Moreover, the traditional methodologies lack the adaptability and scalability required to effectively handle the complexity inherent in identifying patterns amidst the variability and unpredictability of empirical data. Addressing these issues necessitates the development of advanced predictive models capable of identifying relevant risk factors well in advance of overt manifestations.

### SUMMARY OF THE DISCLOSURE

The present disclosure solves the technical challenges typically encountered during the use of a conventional method, such as those discussed above. Specifically, the present disclosure solved the technical challenges by training a machine-learning model to predict and manage a condition of an entity.

In some embodiments, a computer-implemented method includes: receiving, by one or more processors, historical data associated with a target entity from a plurality of data sources; deriving, by the one or more processors, one or more features from the historical data; determining, by the one or more processors, a condition of the target entity by applying the one or more features to a machine-learning model, wherein the machine-learning model has been trained by: receiving a plurality of datasets associated with each entity of a plurality of entities; determining a specific condition associated with each entity of the plurality of entities based on the plurality of datasets; generating an identifier for each entity of the plurality of entities based on the determined specific condition; deriving one or more training features for each entity of the plurality of entities from historical training data associated with the entity; and inputting the identifier and the one or more training features for each entity to the machine-learning model to learn associations between the identifiers and the training features associated with the plurality of entities.

In some embodiments, a system for one or more processors of a computing system; and at least one non-transitory computer readable medium storing instructions which, when executed by the one or more processors, cause the one or more processors to perform operations including: receiving historical data associated with a target entity from a plurality of data sources; deriving one or more features from the historical data; determining a condition of the target entity by applying the one or more features to a machine-learning model, wherein the machine-learning model has been trained by: receiving a plurality of datasets associated with each entity of a plurality of entities; determining a specific condition associated with each entity of the plurality of entities based on the plurality of datasets; generating an identifier for each entity of the plurality of entities based on the determined specific condition; deriving one or more training features for each entity of the plurality of entities from historical training data associated with the entity; and inputting the identifier and the one or more training features for each entity to the machine-learning model to learn associations between the identifiers and the training features associated with the plurality of entities.

In some embodiments, a non-transitory computer readable medium storing instructions which, when executed by one or more processors of a computing system, cause the one or more processors to perform operations including: receiving historical data associated with a target entity from a plurality of data sources; deriving one or more features from the historical data; determining a condition of the target entity by applying the one or more features to a machine-learning model, wherein the machine-learning model has been trained by: receiving a plurality of datasets associated with each entity of a plurality of entities; determining a specific condition associated with each entity of the plurality of entities based on the plurality of datasets; generating an identifier for each entity of the plurality of entities based on the determined specific condition; deriving one or more training features for each entity of the plurality of entities from historical training data associated with the entity; and inputting the identifier and the one or more training features for each entity to the machine-learning model to learn associations between the identifiers and the training features associated with the plurality of entities.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system for predicting the condition of an entity using machine-learning models, according to aspects of the disclosure.

FIG. 2 is a flowchart of a process for predicting the undiagnosed condition of undocumented or delayed documented entities, according to aspects of the disclosure.

FIG. 3 is a flow diagram that illustrates the process for identifying the condition for undocumented or delayed documented entities, according to aspects of the disclosure.

FIG. 4 illustrates a process for identifying and labeling undiagnosed entities based on pre-defined rules, according to aspects of the disclosure.

FIG. 5 shows an example machine-learning training flow chart.

FIG. 6 illustrates an implementation of a computer system that executes techniques presented herein.

### DETAILED DESCRIPTION OF EMBODIMENTS

This present disclosure relates generally to the field of data processing and predictive analytics. In particular, the present disclosure relates to analyzing data utilizing machine-learning methodologies for predicting the condition of an entity.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the embodiments are not to be considered as limited by the foregoing description.

Various non-limiting embodiments of the present disclosure will now be described to provide an overall understanding of the principles of the structure, function, and use of systems and methods disclosed herein for analyzing data utilizing machine-learning methodologies for predicting the condition of an entity.

Conventional approaches in data analysis encounter technical challenges when addressing the complexities inherent in delayed or absent datasets (e.g., categorical identifiers). Traditional methodologies often employ static algorithms that assume complete and timely data availability, thus failing to capture the nuanced temporal dependencies inherent in real-world datasets. The rigid structure of the traditional methods struggles to incorporate new data points in real-time, hindering their ability to capture emerging trends or anomalies. Consequently, these approaches struggle to discern meaningful patterns amidst the sporadic appearance of the categorical identifiers, leading to suboptimal predictive performance.

In addition, the conventional methods may overlook crucial temporal dependencies, undermining the ability to extract meaningful insights from the data. For example, the traditional data processing methods exhibit limitations in handling irregularities associated with missing or delayed information, and lack sophistication to discern the underlying patterns in incomplete datasets. These technical constraints exacerbate the challenges posed by delayed or absent datasets, impeding the development of accurate and reliable predictive models.

Addressing the aforementioned technical challenges necessitates the development of innovative solutions that leverage advanced techniques to enhance predictive modeling capabilities. System 100 provides methodologies that overcome the limitations of conventional methods by effectively capturing temporal dependencies, integrating the sporadic appearances of the datasets (e.g., categorical identifiers), and continuously refining the predictive accuracy of the models. The system 100 applies machine-learning algorithms (e.g., supervised deep-learning model) tailored for handling incomplete datasets. The machine-learning algorithms employ sophisticated strategies (e.g., extracting relevant insight from heterogeneous data sources) to infer the most likely values for missing data, thereby enabling comprehensive analysis and prediction of the entity's condition. In one example, the utilization of a supervised deep-learning architecture enables extraction of intricate patterns and dependencies from complex datasets, leading to more nuanced and accurate predictions. The adaptability of the machine-learning algorithms to evolving data streams allows for continuous learning and refinement, ensuring that predictive performance remains robust over time. Additionally, the scalability of the machine-learning techniques enables the processing of large-scale datasets with ease, facilitating seamless integration into existing operational workflows.

In one embodiment, the system 100 receives historical data associated with a target entity from a plurality of data sources (e.g., lab databases, pharmacy databases, and other relevant sources). By collecting comprehensive historical data from multiple sources, the system 100 establishes a rich foundation for subsequent analysis, enabling robust profiling of a plurality of entities, trend identification, and predictive modeling for proactive management of the condition of the plurality of entities. The system 100 derives one or more features from the historical data. In one instance, the system 100 identifies relevant variables, patterns, and relationships within the data to derive one or more informative features. The features encapsulate the key profile of the target entity, treatment history, and/or risk factors associated with the condition of the target entity.

The system 100 determines a condition of the target entity by applying the derived features to a trained machine-learning model. This system 100 utilizes the predictive capabilities of the machine-learning model, which have been developed through extensive training on labeled data. By inputting the relevant features derived from the historical data, the machine-learning model generates predictions regarding the condition of the target entity. This predictive assessment provides valuable insights into the condition of the target entity, allowing for timely interventions, personalized treatments, and proactive management strategies aimed at improving the condition of the target entity.

The above technical improvements, and additional technical improvements, will be described in detail throughout the present disclosure. Also, it should be apparent to a person of ordinary skill in the art that the technical improvements of the embodiments provided by the present disclosure are not limited to those explicitly discussed herein, and that additional technical improvements exist.

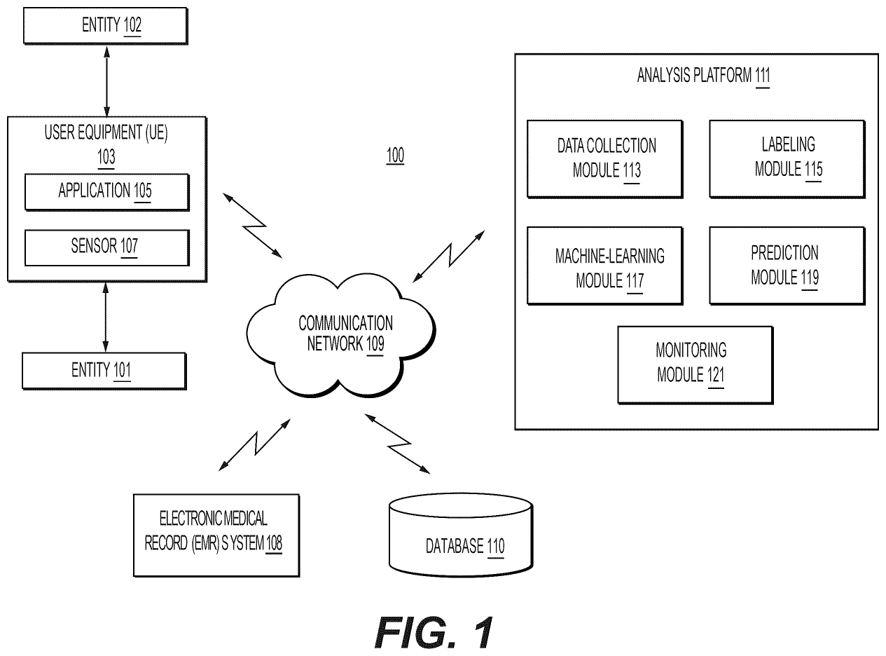

FIG. 1 introduces a capability to implement modern communication and data processing capabilities into methods and systems for predicting the condition of an entity using machine-learning models. FIG. 1, an example architecture of one or more example embodiments of the present disclosure, includes the system 100 that comprises entity 101, entity 102, user equipment (UE) 103 that includes application 105 and sensor 107, electronic medical records (EMR) system 108, a communication network 109, a database 110, and an analysis platform 111.

In one embodiment, the entity 101 includes a person or a group of people interacting with a user interface or a web interface of the UE 103 to access a service (e.g., a health-related service). In one example, the entity 101 includes a registered patient, a target patient, a returning patient, a visiting patient, an authorized user, a visiting user, etc., that provides contextual information for accessing the service. The entity 101 actively engages in initiatives aimed at promoting transparency, collaboration, and patient-centered care by providing access to their medical records, treatment histories, and health-related data. By actively participating, the patient enables the system 100 to gain comprehensive insights into their health status, facilitate informed decision-making, and tailor treatment plans to individual needs effectively.

In one embodiment, the entity 102 includes service providers (e.g., physicians, nurses, medical staff, medical professionals, etc.) that interact with a user interface or a web interface of the UE 103 to share health information pertaining to their patients (e.g., entity 101). The entity 102 facilitates the exchange of critical patient data, including medical records, diagnostic reports, laboratory reports (hereinafter lab reports), treatment plans, and clinical observations. By participating, the entity 102 contributes to enhancing the continuity of care and fosters a holistic understanding of the patient's health status, leading to more informed clinical decision-making.

In one instance, the UE 103 includes, but is not restricted to, any type of mobile terminal, wireless terminal, fixed terminal, or portable terminal. Examples of the UE 103, include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 103 facilitates various input means for receiving and generating information, including, but not restricted to, a touch screen capability, a keyboard, and keypad data entry, a voice-based input mechanism, and the like. Any known and future implementations of the UE 103 are also applicable. In one example, by utilizing the touchscreens and voice-based input mechanism of the UE 103, the entity 102 can input medical history, treatment history, and diagnosis data with ease.

In one instance, the application 105 includes various applications such as, but not restricted to, content provisioning applications, software applications, networking applications, multimedia applications, camera/imaging applications, storage services, contextual information determination services, location-based services, notification services, and the like. In one embodiment, application 105 at the UE 103 acts as a client for the analysis platform 111 and performs one or more functions associated with the functions of the analysis platform 111 by interacting with the analysis platform 111 over the communication network 109.

By way of example, the sensor 107 includes any type of sensor. In one instance, the sensors 107 include, for example, a network detection sensor for detecting wireless signals or receivers for different short-range communications (e.g., Bluetooth, Wi-Fi, Li-Fi, near field communication (NFC), etc.) from the communication network 109, a camera/imaging sensor for gathering image data (e.g., images of medical reports of the patients), an audio recorder for gathering audio data (e.g., recordings of medical treatments or medical diagnosis of the patients), and the like.

In one embodiment, the EMR system 108 is an automated system for capturing data (e.g., medical or health data) associated with the patients from various databases (e.g., healthcare provider databases, state government databases, federal government databases, public health institutions databases (e.g., Center for Medicare & Medicaid Services (CMS) database), etc.) to generate electronic records for transmission to participating systems (e.g., the analysis platform 111). The EMR system 108 transforms a patient's medical chart from a static record into a dynamic, comprehensive record linked to various databases. The EMR system 108 utilizes procedural codes (e.g., current procedural terminology (CPT) codes, international classification of diseases (ICD) codes, etc.) for documenting procedures, diagnoses, and treatments. In one example, when determining whether the entity 101 has a diabetes-related condition, the analysis platform 111 relies on the presence of specific ICD codes associated with the diabetes diagnoses. These codes, such as those from the ICD-10 series, provide a structured and universally recognized method for classifying diabetes and its complications, enabling accurate documentation. The CPT codes are employed to denote standardized descriptions and identifiers for medical services and procedures (e.g., diabetics-related procedures, tests, or treatments) performed on the entity 101. By leveraging these codes, the analysis platform 111 efficiently assesses health status and tracks disease progression.

In one embodiment, various elements of the system 100 communicate with each other through the communication network 109. The communication network 109 supports a variety of different communication protocols and communication techniques. In one embodiment, the communication network 109 allows the analysis platform 111 to communicate with the UE 103. The communication network 109 of the system 100 includes one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one embodiment, the database 110 is any type of database, such as relational, hierarchical, object-oriented, and/or the like, wherein data are organized in any suitable manner, including data tables or lookup tables. The database 110 accesses or includes any suitable data that may be utilized to predict the condition of an entity. In one example, database 110 includes a laboratory database (hereinafter lab database) that serves as a rich repository of clinical data, providing valuable insights into health status and diagnostic indicators associated with the entity 101. It encompasses a wide array of information, including various medical tests relevant for monitoring and managing a condition of the entity 101 (e.g., diabetes). In one example, database 110 includes a pharmacy database that provides information regarding medication history and prescription patterns of the entity 101. It encompasses records of medications dispensed, dosage regimen, refill histories, and adherence patterns, providing a comprehensive overview of medication use by the entity 101. For example, the pharmacy database enables the identification of anti-diabetic medications, facilitating proactive identification of patients at risk for undiagnosed or relayed-diagnosed diabetes. In one example, database 110 includes a micro and macro vascular conditions/complications database (hereinafter complications database) that provides information regarding vascular health status and associated complications for the entity 101. It encompasses a wide range of clinical data, including records of vascular assessment and clinical outcomes related to micro and macro vascular complications such as cardiovascular disease, diabetic retinopathy, neuropathy, and so on. In one example, database 110 includes a claims database that provides information regarding standardized codes such as CPT codes and ICD codes that facilitate diagnosis and treatments.

In one embodiment, the database 110 stores content associated with the entity 101 and the analysis platform 111, and manages multiple types of information that provide means for aiding in the content provisioning and sharing process. In one embodiment, the database 110 includes a machine-learning based training database with a pre-defined mapping defining a relationship between various input parameters and output parameters based on various statistical methods. For example, the training database includes machine-learning algorithms to learn mappings between input parameters related to the entity 101 (e.g., health-related information). The training database is routinely updated and/or supplemented based on machine-learning methods.

In one embodiment, the analysis platform 111 is a platform with multiple interconnected components. The analysis platform 111 includes one or more servers, intelligent networking devices, computing devices, components, and corresponding software for utilizing integrated data sources, machine-learning models, and standardized medical coding for predicting and managing the conditions of target entities. In addition, it is noted that the analysis platform 111 may be a separate entity of the system 100.

Diabetes stands as a costly chronic illness, especially when left undiagnosed or undocumented. Timely identification and documentation of diabetes are paramount, as they enable timely interventions aimed at mitigating the risk of diabetes-related complications. While diagnosis information in medical claims serves as the primary means to identify diabetic members, it is frequently observed that a substantial proportion of diabetic cases either remain absent from the medical claim data or manifest after considerable time lapses, indicative of delayed diagnoses. This phenomenon underscores a critical challenge in healthcare management, as delayed or missed diagnoses hinder the timely provision of essential care and interventions. Un-diagnosed and delayed diagnosed diabetics are the biggest road blockers for pro-active diabetes management through care interventions. It should be understood that the principles discussed herein are applicable to any other type of illness.

In one example, undiagnosed and delayed diagnoses are frequently encountered among patients who have been prescribed anti-diabetic medication for an extended period, as they may not undergo comprehensive diagnostic evaluations, leading to the potential oversight of underlying diabetes or related conditions. In one example, while diagnostic tests like HbA1c provide valuable insights into long-term blood glucose levels, they may not prompt immediate diagnostic action or thorough follow-up assessment. In one example, patients diagnosed with complications that may be potentially linked to diabetes, such as cardiovascular disease or kidney disease may initially manifest with subtle symptoms that are not immediately recognized as diabetic-related. The focus is on managing the presenting symptoms rather than conducting a comprehensive diabetic evaluation. The current methodologies face technical difficulties in addressing the challenges of undiagnosed and delayed diagnoses. The deficiencies of the current methodologies underscore the urgent need for effective diagnostic strategies capable of accurately identifying undiagnosed and delayed cases and implementing effective management strategies.

The analysis platform 111 provides a two-step methodology for identifying the entity 101 (e.g., patients) whose clinical indicators suggest a health-related condition (e.g., diabetes) but have not received a formal diagnosis (undocumented). Firstly, by leveraging data from diverse sources, the analysis platform 111 identifies the entity 101 exhibiting patterns indicative of risk factors or symptoms of a particular health condition (e.g., diabetes), even in the absence of formal diagnoses. The analysis platform 111 labels undocumented entity 101 (e.g., flag patients for undocumented diabetes or delayed documented diabetes) using in-direct and non-obvious signals derived from various data sources. In one example, the data sources include a lab database that provides past medical tests associated with the entity 101 (e.g., glucose-related medical test) that facilitates the analysis platform 111 in determining whether the entity 101 previously tested positive for diabetes. In one example, the data sources include a pharmacy database that provides prescription patterns associated with the entity 101 (e.g., anti-diabetic medication or insulin, duration of such prescription, etc.) to facilitate the analysis platform 111 in determining diabetes risk factors or a need for further evaluation and diagnostic testing to confirm the presence of diabetes in the entity 101. In one example, the data sources include the complications database. By integrating data from such specialized databases, the analysis platform 111 gains access to valuable insights into the vascular health of patients, including the presence of conditions such as diabetic retinopathy, nephropathy, and cardiovascular disease. The analysis platform 111 identifies the entity 101 exhibiting signals indicative of potential vascular complications associated with diabetes enabling proactive interventions aimed at preventing or mitigating the progression of these conditions.

Secondly, the analysis platform 111 utilizes the labeled dataset to develop a machine-learning model (e.g., supervised deep-learning model) to predict or identify potential undocumented patients (e.g., the entity 101) who exhibit patterns suggestive of undiagnosed or delayed-diagnosed conditions. Leveraging advanced algorithms and techniques, the machine-learning model learns from the labeled dataset to identify relevant features associated with risk factors and symptoms of a condition of the entity 101. Implementation of the machine-learning model is discussed in detail below.

In one embodiment, the analysis platform 111 comprises a data collection module 113, a labeling module 115, a machine-learning module 117, a prediction module 119, a monitoring module 121, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one embodiment, the data collection module 113 collects relevant data associated with the entity 101 (e.g., health-related data) through various data collection techniques. In one example, the data collection module 113 uses a web-crawling component to access various databases (e.g., the EMR system 108, the database 110, or other information sources), to collect the relevant data. Through seamless interaction with various databases, the data collection module 113 captures real-time data updates, ensuring data accuracy and completeness, minimizing errors, and enhancing the reliability of the collected data. In one example, the data collection module 113 includes various software applications (e.g., data mining applications in Extended Meta Language (XML)) that automatically search for and return relevant data associated with the entity 101. In one embodiment, the data collection module 113 performs data standardization and/or data cleansing on the collected data. In one example, data standardization includes standardizing and unifying data so that the data are easily processed by other modules. In one example, data cleansing includes removing or correcting erroneous data (e.g., redundant, incomplete, or incorrect data) to create high-quality data or validating and correcting values against a known list of entities. The data cleansing technique also includes data enhancement, where data is made more complete by adding related information. In one example, the entity 101 may have multiple records of the same test on the same date, and the data collection module 113 prioritizes the minimum value for consideration. This ensures consistency and accuracy in data interpretation, mitigating the potential impact of outliers or irregularities in test results.

The data collection module 113 transmits the collected data to the labeling module 115. The labeling module 115 processes the data for identifying and categorizing patients (e.g. the entity 101) exhibiting signals indicative of potential undiagnosed or delayed-diagnosed conditions. The labeling module 115 systematically analyzes the data associated with the entity 101 to assign appropriate labels based on pre-defined criteria. In one example, the pre-defined criteria may include abnormal lab test results, prescription patterns for anti-diabetic medications, diagnostic markers such as HbA1c levels, and clinical indicators of vascular complications related to diabetes. By leveraging sophisticated algorithms and data analytics techniques, the labeling module 115 ensures accurate identification of patients at risk. Through systematic labeling, the analysis platform 111 can prioritize resources effectively and optimize clinical decision-making processes.

In one example, the labeling module 115 utilizes indirect and non-obvious signals from the database 110 to identify undocumented patients at risk of undiagnosed or delayed diagnosed diabetes. Leveraging these non-obvious signals enables the labeling module 115 to systematically label patterns that may otherwise go unnoticed. Lab results play a crucial role in validating the diabetic status of the entity 101, with specific codes aiding in the diagnosis process. In one example, the signals include clinically related signals in the lab database. The data collection module 113 collects LIONC code 4584-4 which corresponds to the measurement of HbA1C levels, providing essential insights into long-term blood glucose control. Additionally, the data collection module 113 collects code 27353-2 which pertains to glucose levels, aiding in the assessment of current blood sugar levels. The labeling module 115 utilizes the lab results to identify and label the entity 101 based on pre-defined criteria related to diagnosis or risk assessment.

In one example, the labeling module 115 classifies the entity 101 as positive for an illness (e.g., diabetes), and the criterion often involves positive results in multiple diagnostic tests. This approach enhances diagnostic accuracy and reduces the likelihood of false positives. For example, in diabetes diagnosis, the entity 101 needs to exhibit elevated levels of both HbA1C (4584-4) and glucose (27353-2) in their lab tests to be labeled as positive for the condition. A common threshold for HbA1C levels is set at greater than 6.4%, while for glucose levels, it is set at greater than 199 mg/dl. These thresholds serve as diagnostic criteria, indicating elevated blood sugar levels consistent with diabetes mellitus. Therefore, patients who test above these thresholds in both HbA1C and glucose tests are classified as positive for diabetes. In one instance, records with HbA1C results greater than 20 units and glucose results less than 0 units are excluded, as they likely represent errors or outliers. Additionally, HbA1C results with units in mg/dl are also excluded to maintain consistency and accurate interpretation of test results. In another example, the labeling module 115 classifies the entity 101 as positive for an illness upon determining the entity 101 tested positive for HbA1C or glucose test more than twice within a pre-determined time threshold (e.g., last twelve months).

In one example, the entity 101 on anti-diabetic medication for an extended period (more than 180 days in the last 12 months), as indicated by their pharmacy claims, is labeled as positive for a condition (e.g., diabetes) by the labeling module 115. This is based on an exhaustive list of national drug code (NDC) corresponding to anti-diabetic medications, for example:

TABLE 1

| Category | GPI | Description |
|---|---|---|
| Oral anti-diabetic | 2750 | Alpha glucose inhibitors |
| Oral anti-diabetic | 2799 | Antidiabetic combination |
| Oral anti-diabetic | 2725 | Biguanide |
| Oral anti-diabetic | 2755 | Dipeptidyl peptidase-4 (DDP-4) inhibitors |
| Oral anti-diabetic | 2757 | Dopamine receptor agnostic-antidiabetic |
| Oral anti-diabetic | 2728 | Meglitinide analogues |
| Oral anti-diabetic | 2720 | Sulfonylureas |
| Oral anti-diabetic | 2760 | Insulin sensitizing agents |
| Insulin | 2710 | Insulin |
| Other anti-diabetic | 2715 | Amylin analogs |
| Other anti-diabetic | 2730 | Diabetic other |
| Other anti-diabetic | 2717 | Incretin mimetic agents |
| Other anti-diabetic | 2770 | GLP-1 receptor agnostics |

This comprehensive list encompasses NDCs sourced from various authoritative references such as the generic product identifier (GPI) database.

In one example, diabetes-related complications include chronic kidney disease (CKD), urinary tract infections, foot problems, heart failure, neuropathy, nephropathy, retinopathy, transient ischemic attacks, cerebrovascular diseases, subarachnoid hemorrhage, cerebral infarction, ischemic heart disease, PAD, and more. The labeling module 115 integrates the diabetes-related complications with relevant data from the database 110 (e.g., lab database, pharmacy database). If lab/pharmacy data and diabetes-related complications meet the criteria, labeling module 115 labels the entity 101 as having diabetes. For example, if the entity 101 exhibits a specific diabetes-related complications, such as diabetic retinopathy, in conjunction with abnormal lab results indicative of elevated HbA1C (4584-4) and glucose (27353-2), and concurrent use of anti-diabetic mediations identified through pharmacy claims, they meet the criteria for a diagnosis of diabetes.

The labeling module 115 provides the labeled dataset to the machine-learning module 117. In one embodiment, the machine-learning module 117 is configured for supervised machine-learning that utilizes training data, e.g., training data 512 illustrated in the training flow chart 500, for training a machine-learning model configured to predict the entity 101 who have diabetes but have not yet been documented. The machine-learning module 117 performs model training using training data, e.g., data from other modules, that contains input and correct output, to allow the model to learn over time. The training is performed based on the deviation of a processed result from a documented result when the inputs are fed into the machine-learning model, e.g., an algorithm measures its accuracy through the loss function, adjusting until the error has been sufficiently minimized. In one example, the labeled dataset serves as the foundation for training the machine learning model, the machine learning model analyzes the input features and corresponding labels to identify patterns and relationships. By leveraging the labeled dataset, the machine learning model iteratively adjusts its parameters and optimizes its predictive capabilities to develop an accurate algorithm for identifying undocumented or at-risk diabetic patients.

In one example, the dependent variable or target variable is defined as the outcome predicted by the machine learning model. In one instance, the dependent variable is binary, with a value of 1 indicating that diabetic members flagged as delayed documented or undocumented are labeled as positive, implying that they have diabetes. This binary classification task aims to differentiate between diabetic and non-diabetic patients based on their documentation status. In one instance, out of all diabetes undocumented members (with no ICD 10 diagnosis code present), those who are not identified in the aforementioned category are labeled as negative (binary class: 0), denoting instances where patients do not exhibit delayed documentation or lack of diagnosis.

In one example, the machine-learning model may generate an independent feature to represent population characteristics across historical years, leveraging data from various sources (e.g., medical claims, MMR data, lab data, pharmacy claims, patient demographics, provider demographics, social determinants of health, member's medication adherence, etc.). The independent feature encapsulates trends and patterns observed within the population over time, providing valuable insights into temporal changes and dynamics related to disease prevalence, treatment patterns, and other relevant factors. By incorporating historical data from diverse sources into the creation of independent feature, the machine-learning model captures the multifaceted nature of population health dynamics and improves their predictive accuracy.

In one embodiment, the machine-learning module 117 randomizes the ordering of the training data, visualizes the training data to identify relevant relationships between different variables, identifies any data imbalances, and splits the training data into two parts where one part is for training a model and the other part is for validating the trained model, de-duplicating, normalizing, correcting errors in the training data, and so on. The machine-learning module 117 implements various machine-learning techniques, e.g., deep-learning algorithms, knowledge graphs, association rule learning, neural network (e.g., recurrent neural networks, graph convolutional neural networks, deep neural networks), inductive programming logic, support vector machines, Bayesian models, Gradient boosted machines (GBM), LightGBM (LGBM), Xtra tree classifier, etc.

In one embodiment, the prediction module 119 applies the trained machine-learning models to new data, enabling the prediction of the condition (e.g., diabetes) of the entity 101 either in real-time or on a scheduled basis. The prediction module 119 assesses incoming data streams, identifies patterns indicative of potential risk factors or symptoms, and generates predictions regarding the likelihood of diabetic cases. The prediction module 119 incorporates features such as confidence score or probability estimates for each prediction. These scores provide insight into the model's level of certainty regarding the predicted outcomes. In addition, the prediction module 119 offers interactive visualization tools or dashboards to facilitate the interpretation and communication of prediction results in the user interface of the UE 103, fostering informed decision-making.

In one embodiment, the monitoring module 121 monitors data quality and performance of the machine-learning model, and generates comprehensive reports that summarize the effectiveness of prediction results and data integrity. The monitoring module 121 incorporates anomaly detection algorithms to identify unusual patterns or outliers in performance, data quality, or machine-learning model behavior, enabling prompt investigation and resolution of potential issues. In one example, the monitoring module 121 generates automated alerts when key performance indicators fall below pre-defined thresholds, enabling proactive intervention.

The above presented modules and components of the analysis platform 111 are implemented in hardware, firmware, software, or a combination thereof. Though depicted as a separate entity in FIG. 1, it is contemplated that the analysis platform 111 is also implemented for direct operation by the respective UE 103. As such, the analysis platform 111 generates direct signal inputs by way of the operating system of the UE 103. In another embodiment, one or more of the modules 113-121 are implemented for operation by the respective UEs, as the analysis platform 111. The various executions presented herein contemplate any and all arrangements and models.

By way of example, the UE 103, EMR system 108, database 110, and the analysis platform 111 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

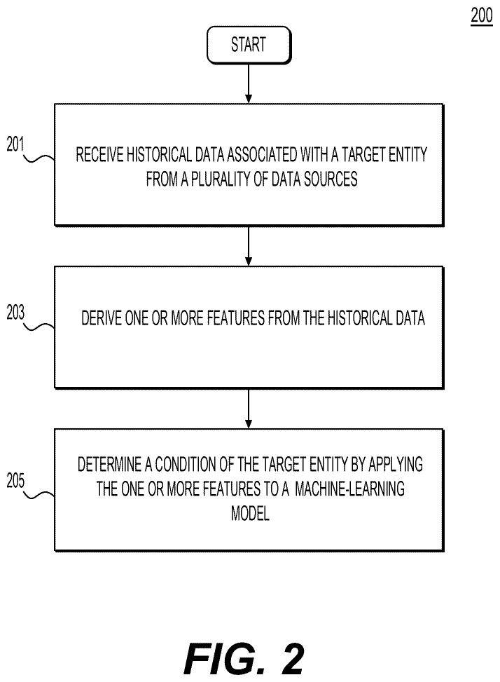

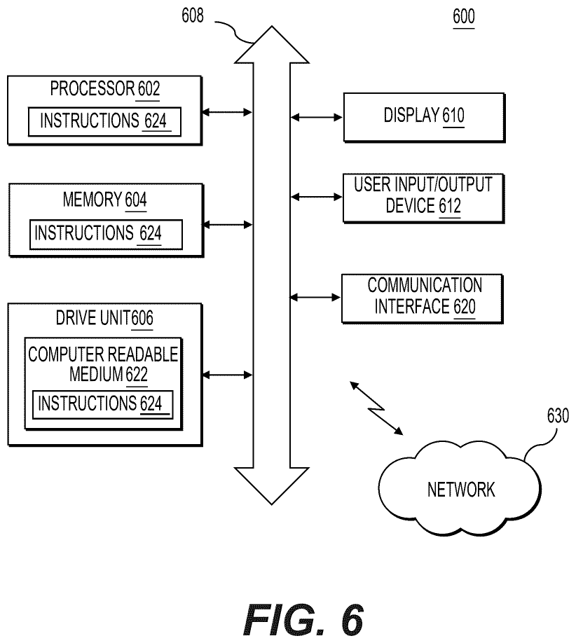

FIG. 2 is a flowchart of a process for predicting the undiagnosed condition of undocumented or delayed documented entities, according to aspects of the disclosure. In various embodiments, the analysis platform 111 and/or any of the modules 113-121 performs one or more portions of the process 200 and are implemented using, for instance, a chip set including a processor and a memory as shown in FIG. 6. As such, the analysis platform 111 and/or any of modules 113-121 provide means for accomplishing various parts of the process 200, as well as means for accomplishing embodiments of other processes described herein in conjunction with other components of the system 100. Although the process 200 is illustrated and described as a sequence of steps, it is contemplated that various embodiments of the process 200 are performed in any order or combination and need not include all of the illustrated steps.

In step 201, the analysis platform 111 receives historical data associated with a target entity (e.g., the entity 101) from a plurality of data sources (e.g., EMR system 108, database 110). In one example, historical data include claims data, electronic medical records, lab or pharmacy data, entity demographics data, provider demographics data, social determinants of health (SDOH) data, and/or entity adherence data. In one example, the plurality of datasets includes a claims dataset, a lab dataset and/or a pharmacy dataset, or a complications dataset.

In step 203, the analysis platform 111 derives one or more features from the historical data. In one example, features derived from the claims data include diagnosis codes, procedure codes, and/or healthcare utilization patterns. In one example, features derived from the lab data include biomarkers, test results, and/or disease progression data. In one example, features derived from pharmacy data include medication usage, adherence rates, and/or prescription patterns. In one example, features derived from SDOH data include socioeconomic disparities, environmental risks, and/or community resources. In one example, features derived from adherence data include treatment effectiveness, patient engagement, and/or health outcomes.

In step 205, the analysis platform 111 determines a condition of the target entity by applying one or more features to a machine-learning model. In one instance, the condition determined for the target entity indicates whether or not the target entity has an undocumented condition or a delayed documented condition. In one example, the machine-learning model is a classification model using a knowledge graph.

In one embodiment, training the machine-learning model includes a plurality of steps performed by one or more modules of the analysis platform 111. The data collection module 113 receives a plurality of datasets associated with each entity of a plurality of entities (e.g., the entity 101). In one example, the plurality of datasets includes the lab database, the pharmacy database, and/or the complications database. The data collection module 113 transmits the plurality of datasets to the labeling module 115. The labeling module 115 processes the plurality of datasets to determine a specific condition associated with each entity. In one instance, the specific condition includes an undocumented condition, a delayed documented condition, or a non-condition. In one example, the undocumented condition indicates a health condition or diagnosis that has not been officially recorded or documented within the medical records of the entity 101. This may occur due to oversight, lack of diagnostic testing, or incomplete documentation by the healthcare providers. In one example, the delayed documentation condition indicates a health condition that is diagnosed or recorded at a later stage than optimal for effective treatment. The delay may result from various factors, such as delayed access to healthcare services, misinterpretation of symptoms, or insufficient diagnostic testing. In one example, a non-condition indicates the absence of any documented health condition in the medical history of the entity 101, implying good health with no reported medical issues.

In one embodiment, the labeling module 115 generates an identifier (e.g., labels) for each entity based on the determined specific condition. In one instance, the identifier generated for the entity includes a first value if the specific condition determined for the entity is the undocumented condition or the delayed documented condition. In one instance, the identifier generated for the entity includes a second value if the specific condition determined for the entity is the non-condition.

In one embodiment, the labeling module 115 determines an absence of one or more classification codes (e.g., ICD codes related to a particular illness) in the claims dataset associated with the entity. The labeling module 115 determines at least one of one or more condition criteria is not met based on at least one of the lab datasets, the pharmacy dataset, and/or the complications dataset. The labeling module 115 determines the specific condition determined for an entity of the plurality of entities is the non-condition. In one example, one or more condition criteria include threshold for certain biomarkers or test results, pattern of medication usage or adherence, or other indicators utilized for assessing and diagnosing a particular health condition. If the data from lab tests or pharmacy records does not meet these pre-defined criteria, it indicates that the entity 101 does not exhibit signs or symptoms consistent with the condition being evaluated.

In one embodiment, the labeling module 115 determines the absence of one or more classification codes in the claims dataset associated with the entity. The labeling module 115 determines that one or more condition criteria are met based on at least one of the lab dataset, the pharmacy dataset, or the complications dataset. The labeling module 115 assigns undocumented condition as the specific condition for the entity.

In one embodiment, the labeling module 115 determines the presence of one or more classification codes in the claims dataset associated with the entity. The labeling module 115 also determines that one or more condition criteria are met based on at least one of the lab dataset, the pharmacy dataset, or the complications dataset, but the condition was documented after a pre-determined time period. The labeling module 115 assigns delayed documented condition as the specific condition for the entity.

In one embodiment, the machine-learning module 117 derives one or more training features for each entity from historical training data associated with the entity.

In one example, the machine-learning module 117 extracts meaningful characteristics or attributes from past datasets to serve as inputs for training the machine-learning model. These features represent relevant information about the data instances, such as medical history, lab results, medication usage, and other pertinent variables. By identifying and selecting the most informative features from the historical data, the training process aims to capture essential patterns and relationships that enable the model to learn and make accurate predictions. The machine-learning module 117 inputs the identifier and one or more training features for each entity to the machine-learning model configured to learn associations between the identifiers and the training features associated with the plurality of entities.

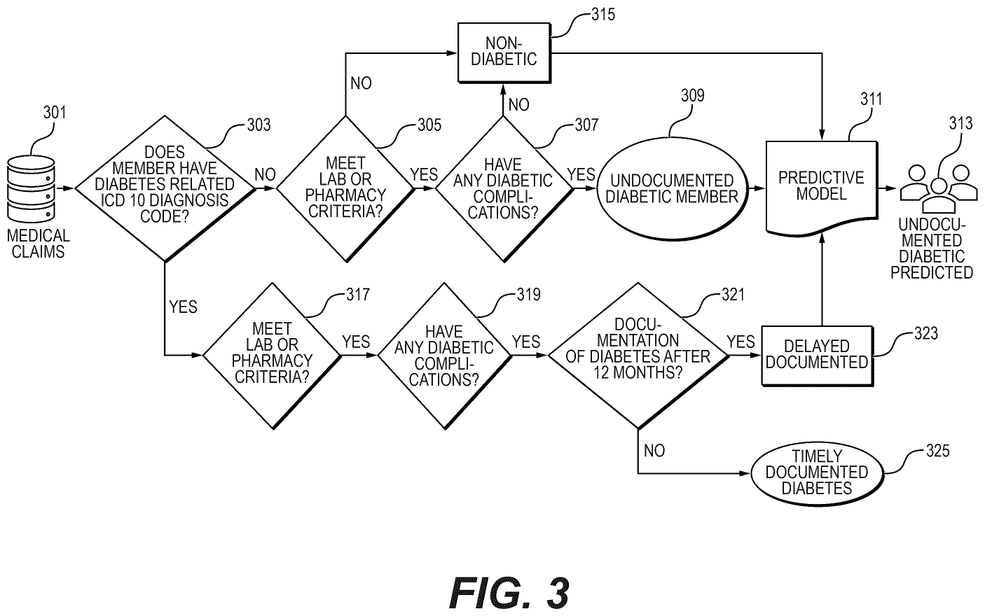

FIG. 3 is a flow diagram that illustrates the process for identifying the condition for undocumented or delayed documented entities, according to aspects of the disclosure. In step 301, the analysis platform 111 processes a first dataset (e.g., claims database) associated with an entity (e.g., the entity 101) in a plurality of data sources (e.g., EMR system 108, database 110). In step 303, the analysis platform 111 determines the presence or absence of a medical code for a specific condition (e.g., ICD code or CPT code relating to diabetes) in the first dataset.

The analysis platform 111 determines the absence of the medical code in the first dataset. In step 305, the analysis platform 111 processes a second dataset (e.g., lab database or pharmacy database) based on past records associated with the entity to determine whether pre-defined criteria are satisfied. The analysis platform 111 determines diagnostic data and compares the diagnostic data to the pre-defined criteria. The analysis platform 111 determines that the diagnostic data meets the pre-defined criteria. For example, the HbA1C levels are greater than the threshold limit of 6.4% and/or the glucose levels are greater than the threshold limit of 199 mg/dL.

In step 307, the analysis platform 111 processes a third dataset (e.g., complications database) to determine any diabetes-related complications. For example, the analysis platform 111 identifies signals indicative of potential vascular complications associated with diabetes. In step 309, the analysis platform 111 labels the entity 101 as undocumented indicating a health condition or diagnosis that has not been officially recorded or documented within the medical records. In step 311, the analysis platform 111 inputs the labeled data to the machine-learning model configured to predict the entity 101 who have a health condition (e.g., diabetes) but not yet documented.

Returning to step 305, the analysis platform 111 determines the diagnostic data is below the pre-defined criteria. For example, the HbA1C levels are below the threshold limit of 6.4% and/or the glucose levels are below the threshold limit of 199 mg/dL. In step 315, the analysis platform 111 labels the entity 101 as non-condition indicating the absence of any documented health condition in the medical history, suggesting good health with no reported medical issues. In step 311, the analysis platform 111 inputs the labeled data to the machine-learning model.

Reverting to step 303, the analysis platform 111 determines the presence of the medical code indicating a diagnosis or related condition in the first dataset. In step 317, the analysis platform 111 processes the second dataset to determine diagnostic data and compares the diagnostic data to the pre-defined criteria. The analysis platform 111 determines that the diagnostic data meets the pre-defined criteria (e.g., elevated HbA1c level or prescription of anti-diabetic medications beyond the threshold level). In step 319, the analysis platform 111 processes the third dataset to determine the presence of diabetes-related complications. In step 321, the analysis platform 111 determines the documentation of the health condition (e.g., diabetes) exceeds a pre-defined time threshold (e.g., spans over 12 months from the initial ICD code diagnosis). In step 323, the analysis platform 111 labels the entity 101 as delayed documentation, indicating a significant time lapse between diagnosis and documentation. The analysis platform 111 inputs the labeled data to the machine-learning model.

Returning to step 321, the analysis platform 111 determines the documentation of the health condition is below the pre-defined time threshold (e.g., below 12 months from the initial ICD code diagnosis). In step 325, the analysis platform 111 labels the entity 101 as timely documented. The analysis platform 111 may input the labeled data to the machine-learning model.

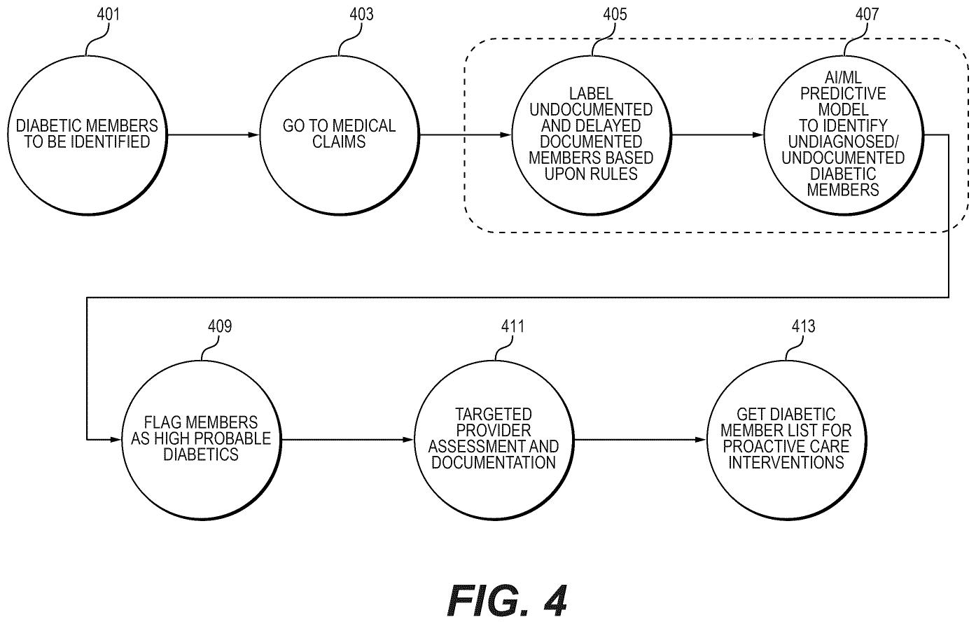

FIG. 4 illustrates a process for identifying and labeling undiagnosed entities based on pre-defined rules, according to aspects of the disclosure. In step 401, the analysis platform 111 identifies the entity 101 to be evaluated for a specific health condition (e.g., diabetes). In step 403, the analysis platform 111 examines medical claims data and other relevant datasets (e.g., lab dataset, pharmacy dataset, complication dataset) associated with the entity 101. As previously discussed, the medical claims data includes valuable information about patient diagnoses and treatments. Within the dataset, the entity 101 is identified for the specific health condition based on specific criteria, such as the presence of relevant ICD codes indicating a diagnosis of the specific health condition.

In step 405, the data is analyzed to label the entity 101 as undocumented or delayed documented applying the pre-defined rules discussed in the present disclosure, highlighting instances where comprehensive documentation of diabetes-related diagnoses and treatments is lacking or delayed. In step 407, a predictive model (e.g., the machine-learning model) is developed based on the process discussed in the present disclosure for identifying undiagnosed members who exhibit patterns indicative of the potential health condition (e.g., diabetes) but have not received formal diagnosis.

In step 409, the analysis platform 111 flags the entity 101 identified as having a high probability of being undiagnosed for further evaluation. This flagging process entails assigning a specific marker or indicator to the entity 101, distinguishing them from the other candidates. By prioritizing these flagged candidates for further assessment, the system optimizes resource allocation and enhances the effectiveness of diabetes detection.

In step 411, targeted provider assessment and documentation include focused attention and resources towards the entity 102 which cares for candidates flagged as having a high probability of being undiagnosed for a health condition (e.g., diabetes). In step 413, the analysis platform 111 obtains a list of the entity 101 with a high probability for the specific health condition for proactive care interventions.

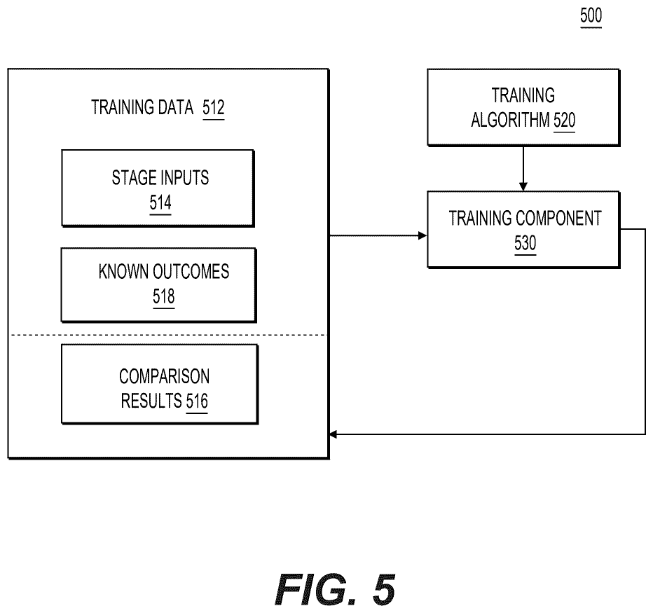

One or more implementations disclosed herein include and/or are implemented using a machine-learning model. For example, one or more of the modules of the analysis platform 111 are implemented using a machine-learning model and/or are used to train the machine-learning model. A given machine-learning model is trained using the training flow chart 500 of FIG. 5. Training data 512 includes one or more of stage inputs 514 and known outcomes 518 related to the machine-learning model to be trained. Stage inputs 514 are from any applicable source including text, visual representations, data, values, comparisons, and stage outputs, e.g., one or more outputs from one or more steps from FIG. 2. The known outcomes 518 are included for the machine-learning models generated based on supervised or semi-supervised training. An unsupervised machine-learning model is not be trained using known outcomes 518. Known outcomes 518 includes known or desired outputs for future inputs similar to or in the same category as stage inputs 514 that do not have corresponding known outputs.

The training data 512 and a training algorithm 520, e.g., one or more of the modules implemented using the machine-learning model and/or are used to train the machine-learning model, is provided to a training component 530 that applies the training data 512 to the training algorithm 520 to generate the machine-learning model. According to an implementation, the training component 530 is provided comparison results 516 that compare a previous output of the corresponding machine-learning model to apply the previous result to re-train the machine-learning model. The comparison results 516 are used by training component 530 to update the corresponding machine-learning model. The training algorithm 520 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the processes illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

FIG. 6 illustrates an implementation of a computer system that executes techniques presented herein. The computer system 600 includes a set of instructions that are executed to cause the computer system 600 to perform any one or more of the methods or computer based functions disclosed herein. The computer system 600 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 600 operates in the capacity of a server or as a client user computer in a server-client user network environment, or as a peer computer system in a peer-to-peer (or distributed) network environment. The computer system 600 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 is implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 includes a processor 602, e.g., a central processing unit (CPU), a graphics processing unit (GPU), or both. The processor 602 is a component in a variety of systems. For example, the processor 602 is part of a standard personal computer or a workstation. The processor 602 is one or more processors, digital signal processors, application specific integrated circuits, field programmable gate arrays, servers, networks, digital circuits, analog circuits, combinations thereof, or other now known or later developed devices for analyzing and processing data. The processor 602 implements a software program, such as code generated manually (i.e., programmed).

The computer system 600 includes a memory 604 that communicates via bus 608. Memory 604 is a main memory, a static memory, or a dynamic memory. Memory 604 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. Memory 604 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts, or tasks illustrated in the figures or described herein are performed by processor 602 executing the instructions stored in memory 604. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 600 further includes a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 acts as an interface for the user to see the functioning of the processor 602, or specifically as an interface with the software stored in the memory 604 or in the drive unit 606.

Additionally or alternatively, the computer system 600 includes an input/output device 612 configured to allow a user to interact with any of the components of the computer system 600. The input/output device 612 is a number pad, a keyboard, a cursor control device, such as a mouse, a joystick, touch screen display, remote control, or any other device operative to interact with the computer system 600.

The computer system 600 also includes the drive unit 606 implemented as a disk or optical drive. The drive unit 606 includes a computer-readable medium 622 in which one or more sets of instructions 624, e.g. software, is embedded. Further, the sets of instructions 624 embodies one or more of the methods or logic as described herein. Instructions 624 resides completely or partially within memory 604 and/or within processor 602 during execution by the computer system 600. The memory 604 and the processor 602 also include computer-readable media as discussed above.

In some systems, computer-readable medium 622 includes the set of instructions 624 or receives and executes the set of instructions 624 responsive to a propagated signal so that a device connected to network 630 communicates voice, video, audio, images, or any other data over network 630. Further, the sets of instructions 624 are transmitted or received over the network 630 via the communication port or interface 620, and/or using the bus 608. The communication port or interface 620 is a part of the processor 602 or is a separate component. The communication port or interface 620 is created in software or is a physical connection in hardware. The communication port or interface 620 is configured to connect with the network 630, external media, display 610, or any other components in the computer system 600, or combinations thereof. The connection with network 630 is a physical connection, such as a wired Ethernet connection, or is established wirelessly as discussed below. Likewise, the additional connections with other components of the computer system 600 are physical connections or are established wirelessly. Network 630 alternatively be directly connected to the bus 608.

While the computer-readable medium 622 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 622 is non-transitory, and may be tangible.

The computer-readable medium 622 includes a solid-state memory such as a memory card or other package that houses one or more non-volatile read-only memories. The computer-readable medium 622 is a random-access memory or other volatile re-writable memory. Additionally or alternatively, the computer-readable medium 622 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 600 is connected to network 630. Network 630 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. Network 630 includes wide area networks (WAN), such as the Internet, local area networks (LAN), campus area networks, metropolitan area networks, a direct connection such as through a Universal Serial Bus (USB) port, or any other networks that allows for data communication. Network 630 is configured to couple one computing device to another computing device to enable communication of data between the devices. Network 630 is generally enabled to employ any form of machine-readable media for communicating information from one device to another. Network 630 includes communication methods by which information travels between computing devices. Network 630 is divided into sub-networks. The sub-networks allow access to all of the other components connected thereto or the sub-networks restrict access between the components. Network 630 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the present disclosure, various features are sometimes grouped together in a single embodiment, figure, or description thereof for the purpose of streamlining the disclosure and aiding in the understanding of one or more of the various inventive aspects. This method of the present disclosure, however, is not to be interpreted as reflecting an intention that the claimed embodiments require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the present disclosure.

In the description provided herein, numerous specific details are set forth. However, it is understood that embodiments of the present disclosure are practiced without these specific details. In other instances, well-known methods, structures and techniques have not been shown in detail in order not to obscure an understanding of this description.

Thus, while there has been described what are believed to be the preferred embodiments of the present disclosure, those skilled in the art will recognize that other and further modifications are made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure furthermore relates to the following aspects.

Example 1. A computer-implemented method comprising: receiving, by one or more processors, historical data associated with a target entity from a plurality of data sources; deriving, by the one or more processors, one or more features from the historical data; determining, by the one or more processors, a condition of the target entity by applying the one or more features to a machine-learning model, wherein the machine-learning model has been trained by: receiving a plurality of datasets associated with each entity of a plurality of entities; determining a specific condition associated with each entity of the plurality of entities based on the plurality of datasets; generating an identifier for each entity of the plurality of entities based on the determined specific condition; deriving one or more training features for each entity of the plurality of entities from historical training data associated with the entity; and inputting the identifier and the one or more training features for each entity to the machine-learning model to learn associations between the identifiers and the training features associated with the plurality of entities.

Example 2. The computer-implemented method of example 1, wherein the condition determined for the target entity indicates whether or not the target entity has an undocumented condition or a delayed documented condition.

Example 3. The computer-implemented method of any of examples 1-2, wherein the specific condition determined for each entity is one of: an undocumented condition, a delayed documented condition, or a non-condition.

Example 4. The computer-implemented method of example 3, wherein the plurality of datasets associated with each entity include one or more of: a claims dataset; a lab dataset and/or a pharmacy dataset; or a complications dataset.

Example 5. The computer-implemented method of example 4, wherein, when the specific condition determined for an entity of the plurality of entities is the non-condition, determining the specific condition associated with the entity comprises: determining an absence of one or more classification codes in the claims dataset associated with the entity; and determining at least one of one or more condition criteria is not met based on at least one of the lab dataset, the pharmacy dataset, or the complications dataset.

Example 6. The computer-implemented method of any of examples 4-5, wherein, when the specific condition determined for an entity of the plurality of entities is the undocumented condition, determining the specific condition associated with the entity comprises: determining an absence of one or more classification codes in the claims dataset associated with the entity; and determining one or more condition criteria are met based on at least one of the lab dataset, the pharmacy dataset, or the complications dataset.

Example 7. The computer-implemented method of any of examples 4-6, wherein, when the specific condition determined for an entity of the plurality of entities is the delayed documented condition, determining the specific condition associated with the entity comprises: determining a presence of one or more classification codes in the claims dataset associated with the entity; determining one or more condition criteria are met based on at least one of the lab dataset, the pharmacy dataset, or the complications dataset; and determining that a condition was documented after a pre-determined time period.

Example 8. The computer-implemented method of any of examples 3-7, wherein the identifier generated for an entity includes: a first value if the specific condition determined for the entity is the undocumented condition or the delayed documented condition, or a second value if the specific condition determined for the entity is the non-condition.

Example 9. The computer-implemented method of any of examples 1-8, wherein the historical data includes at least one of: claims data; electronic medical records; lab or pharmacy data; entity demographics data; provider demographics data; social determinants of health (SDOH) data; or entity adherence data.

Example 10. The computer-implemented method of any of examples 1-9, wherein the machine-learning model is a classification model using a knowledge graph.

Example 11. A system comprising: one or more processors of a computing system; and at least one non-transitory computer readable medium storing instructions which, when executed by the one or more processors, cause the one or more processors to perform operations comprising: receiving historical data associated with a target entity from a plurality of data sources; deriving one or more features from the historical data; determining a condition of the target entity by applying the one or more features to a machine-learning model, wherein the machine-learning model has been trained by: receiving a plurality of datasets associated with each entity of a plurality of entities; determining a specific condition associated with each entity of the plurality of entities based on the plurality of datasets; generating an identifier for each entity of the plurality of entities based on the determined specific condition; deriving one or more training features for each entity of the plurality of entities from historical training data associated with the entity; and inputting the identifier and the one or more training features for each entity to the machine-learning model to learn associations between the identifiers and the training features associated with the plurality of entities.

Example 12. The system of example 11, wherein the condition determined for the target entity indicates whether or not the target entity has an undocumented condition or a delayed documented condition.

Example 13. The system of any of examples 11-12, wherein the specific condition determined for each entity is one of: an undocumented condition, a delayed documented condition, or a non-condition.

Example 14. The system of example 13, wherein the plurality of datasets associated with each entity include one or more of: a claims dataset; a lab dataset and/or a pharmacy dataset; or a complications dataset.

Example 15. The system of example 14, wherein, when the specific condition determined for an entity of the plurality of entities is the non-condition, determining the specific condition associated with the entity comprises: determining an absence of one or more classification codes in the claims dataset associated with the entity; and determining at least one of one or more condition criteria is not met based on at least one of the lab dataset, the pharmacy dataset, or the complications dataset.

Example 16. The system of any of examples 14-15, wherein, when the specific condition determined for an entity of the plurality of entities is the undocumented condition, determining the specific condition associated with the entity comprises: determining an absence of one or more classification codes in the claims dataset associated with the entity; and determining one or more condition criteria are met based on at least one of the lab dataset, the pharmacy dataset, or the complications dataset.

Example 17. The system of any of examples 14-16, wherein, when the specific condition determined for an entity of the plurality of entities is the delayed documented condition, determining the specific condition associated with the entity comprises: determining a presence of one or more classification codes in the claims dataset associated with the entity; determining one or more condition criteria are met based on at least one of the lab dataset, the pharmacy dataset, or the complications dataset; and determining that a condition was documented after a pre-determined time period.

Example 18. A non-transitory computer readable medium, the non-transitory computer readable medium storing instructions which, when executed by one or more processors of a computing system, cause the one or more processors to perform operations comprising: receiving historical data associated with a target entity from a plurality of data sources; deriving one or more features from the historical data; determining a condition of the target entity by applying the one or more features to a machine-learning model, wherein the machine-learning model has been trained by: receiving a plurality of datasets associated with each entity of a plurality of entities; determining a specific condition associated with each entity of the plurality of entities based on the plurality of datasets; generating an identifier for each entity of the plurality of entities based on the determined specific condition; deriving one or more training features for each entity of the plurality of entities from historical training data associated with the entity; and inputting the identifier and the one or more training features for each entity to the machine-learning model to learn associations between the identifiers and the training features associated with the plurality of entities.

Example 19. The non-transitory computer readable medium of example 18, wherein the condition determined for the target entity indicates whether or not the target entity has an undocumented condition or a delayed documented condition.

Example 20. The non-transitory computer readable medium of examples 18-19, wherein the specific condition determined for each entity is one of: an undocumented condition, a delayed documented condition, or a non-condition.

Example 21. The computer-implemented method of Example 1, wherein the training of the machine-learning model is performed by the one or more processors.

Example 22. The computer-implemented method of Example 1, wherein: the one or more processors are included in a first computing entity; and the training of the machine-learning model is performed by one or more processors included in a second computing entity.

What is claimed is:

1. A computer-implemented method comprising:
receiving, by one or more processors, historical data associated with a target entity from a plurality of data sources;
deriving, by the one or more processors, one or more features from the historical data;
determining, by the one or more processors, a condition of the target entity by applying the one or more features to a machine-learning model,
wherein the machine-learning model has been trained by:
receiving a plurality of datasets associated with each entity of a plurality of entities;
determining a specific condition associated with each entity of the plurality of entities based on the plurality of datasets;
generating an identifier for each entity of the plurality of entities based on the determined specific condition;
deriving one or more training features for each entity of the plurality of entities from historical training data associated with the entity; and
inputting the identifier and the one or more training features for each entity to the machine-learning model to learn associations between the identifiers and the training features associated with the plurality of entities.

2. The computer-implemented method of claim 1, wherein the condition determined for the target entity indicates whether or not the target entity has an undocumented condition or a delayed documented condition.

3. The computer-implemented method of claim 1, wherein the specific condition determined for each entity is one of: an undocumented condition, a delayed documented condition, or a non-condition.

4. The computer-implemented method of claim 3, wherein the plurality of datasets associated with each entity include one or more of:
a claims dataset;
a lab dataset and/or a pharmacy dataset; or
a complications dataset.

5. The computer-implemented method of claim 4, wherein, when the specific condition determined for an entity of the plurality of entities is the non-condition, determining the specific condition associated with the entity comprises:
determining an absence of one or more classification codes in the claims dataset associated with the entity; and
determining at least one of one or more condition criteria is not met based on at least one of the lab dataset, the pharmacy dataset, or the complications dataset.

6. The computer-implemented method of claim 4, wherein, when the specific condition determined for an entity of the plurality of entities is the undocumented condition, determining the specific condition associated with the entity comprises:
determining an absence of one or more classification codes in the claims dataset associated with the entity; and
determining one or more condition criteria are met based on at least one of the lab dataset, the pharmacy dataset, or the complications dataset.

7. The computer-implemented method of claim 4, wherein, when the specific condition determined for an entity of the plurality of entities is the delayed documented condition, determining the specific condition associated with the entity comprises:
determining a presence of one or more classification codes in the claims dataset associated with the entity;
determining one or more condition criteria are met based on at least one of the lab dataset, the pharmacy dataset, or the complications dataset; and
determining that a condition was documented after a pre-determined time period.

8. The computer-implemented method of claim 3, wherein the identifier generated for an entity includes:
a first value if the specific condition determined for the entity is the undocumented condition or the delayed documented condition, or
a second value if the specific condition determined for the entity is the non-condition.

9. The computer-implemented method of claim 1, wherein the historical data includes at least one of:
claims data;
electronic medical records;
lab or pharmacy data;
entity demographics data;
provider demographics data;
social determinants of health (SDOH) data; or
entity adherence data.

10. The computer-implemented method of claim 1, wherein the machine-learning model is a classification model using a knowledge graph.

11. A system comprising:
one or more processors of a computing system; and
at least one non-transitory computer readable medium storing instructions which, when executed by the one or more processors, cause the one or more processors to perform operations comprising:
receiving historical data associated with a target entity from a plurality of data sources;
deriving one or more features from the historical data;
determining a condition of the target entity by applying the one or more features to a machine-learning model,
wherein the machine-learning model has been trained by:
receiving a plurality of datasets associated with each entity of a plurality of entities;
determining a specific condition associated with each entity of the plurality of entities based on the plurality of datasets;
generating an identifier for each entity of the plurality of entities based on the determined specific condition;
deriving one or more training features for each entity of the plurality of entities from historical training data associated with the entity; and
inputting the identifier and the one or more training features for each entity to the machine-learning model to learn associations between the identifiers and the training features associated with the plurality of entities.

12. The system of claim 11, wherein the condition determined for the target entity indicates whether or not the target entity has an undocumented condition or a delayed documented condition.

13. The system of claim 11, wherein the specific condition determined for each entity is one of: an undocumented condition, a delayed documented condition, or a non-condition.

14. The system of claim 13, wherein the plurality of datasets associated with each entity include one or more of:
a claims dataset;
a lab dataset and/or a pharmacy dataset; or
a complications dataset.

15. The system of claim 14, wherein, when the specific condition determined for an entity of the plurality of entities is the non-condition, determining the specific condition associated with the entity comprises:
determining an absence of one or more classification codes in the claims dataset associated with the entity; and
determining at least one of one or more condition criteria is not met based on at least one of the lab dataset, the pharmacy dataset, or the complications dataset.

16. The system of claim 14, wherein, when the specific condition determined for an entity of the plurality of entities is the undocumented condition, determining the specific condition associated with the entity comprises:
determining an absence of one or more classification codes in the claims dataset associated with the entity; and
determining one or more condition criteria are met based on at least one of the lab dataset, the pharmacy dataset, or the complications dataset.

17. The system of claim 14, wherein, when the specific condition determined for an entity of the plurality of entities is the delayed documented condition, determining the specific condition associated with the entity comprises:
determining a presence of one or more classification codes in the claims dataset associated with the entity;
determining one or more condition criteria are met based on at least one of the lab dataset, the pharmacy dataset, or the complications dataset; and
determining that a condition was documented after a pre-determined time period.

18. A non-transitory computer readable medium, the non-transitory computer readable medium storing instructions which, when executed by one or more processors of a computing system, cause the one or more processors to perform operations comprising:
receiving historical data associated with a target entity from a plurality of data sources;
deriving one or more features from the historical data;
determining a condition of the target entity by applying the one or more features to a machine-learning model,
wherein the machine-learning model has been trained by:
receiving a plurality of datasets associated with each entity of a plurality of entities;
determining a specific condition associated with each entity of the plurality of entities based on the plurality of datasets;
generating an identifier for each entity of the plurality of entities based on the determined specific condition;
deriving one or more training features for each entity of the plurality of entities from historical training data associated with the entity; and
inputting the identifier and the one or more training features for each entity to the machine-learning model to learn associations between the identifiers and the training features associated with the plurality of entities.

19. The non-transitory computer readable medium of claim 18, wherein the condition determined for the target entity indicates whether or not the target entity has an undocumented condition or a delayed documented condition.

20. The non-transitory computer readable medium of claim 18, wherein the specific condition determined for each entity is one of: an undocumented condition, a delayed documented condition, or a non-condition.
